(19) United States
(12) Patent Application Publication
(10) Pub. No.: US 2014/0240842 A1
(43) Pub. Date: Aug. 28, 2014

(54) ALIGNMENT-INSENSITIVE IMAGE INPUT COUPLING

(71) Applicants: Ian Nguyen, Renton, WA (US); Steve Robbins, Bellevue, WA (US)

(72) Inventors: Ian Nguyen, Renton, WA (US); Steve Robbins, Bellevue, WA (US)

(21) Appl. No.: 13/774,875

(22) Filed: Feb. 22, 2013

(51) Int. Cl. G02B 27/01

(52) U.S. Cl. CPC G02B 27/017
USPC 359/630

(57) ABSTRACT

Various embodiments are disclosed herein that relate to coupling light into waveguides in a near-eye display device in a manner configured to be tolerant to misalignment of the waveguides with each other and/or other optics. For example, one disclosed embodiment provides a near-eye display device comprising one or more waveguides, wherein each waveguide comprises a light input coupling configured to receive light at a first side of the waveguide to couple the light into the waveguide, and a light output coupling configured to emit light from the waveguide at a second side of the waveguide, the second side of the waveguide being opposite the first side of the waveguide.

### BACKGROUND

Near-eye display devices may utilize various optical technologies to deliver an image to an eye of a user. For example, a near-eye augmented reality display may utilize one or more waveguides incorporated into a see-through display configured to be positioned in front of a user's eye(s). In such a device, the waveguide may receive an image from a microdisplay at an input coupling of the waveguide, and transmits the image to an output coupling configured to direct the image toward a user's eye.

### SUMMARY

Various embodiments are disclosed herein that relate to coupling light into waveguides in a near-eye display device in a manner configured to be tolerant to misalignment of the waveguides with each other and/or other optics. For example, one disclosed embodiment provides a near-eye display device comprising one or more waveguides, wherein each waveguide comprises a light input coupling configured to receive light at a first side of the waveguide to couple the light into the waveguide, and a light output coupling configured to emit light from the waveguide at a second side of the waveguide, the second side of the waveguide being opposite the first side of the waveguide.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows an embodiment of a near-eye display device in an example use environment.

FIG. 2 shows a block diagram of a display device in accordance with an embodiment of the present disclosure.

FIG. 3 schematically shows an example embodiment of a waveguide stack.

FIG. 4 schematically illustrates an effect of a misalignment of waveguides where an input coupling and output coupling are on a same side of each waveguide.

FIG. 5 schematically illustrates an effect of a misalignment of waveguides where an input coupling and output coupling are on an opposite side of each waveguide according to an embodiment of the present disclosure.

FIG. 6 schematically illustrates a directing of light around an edge of a stack of waveguides to reach an input coupling at an opposite side of each waveguide as an output coupling according to an embodiment of the present disclosure.

FIGS. 7A and 7B schematically illustrate an effect of a misalignment of a waveguide with respect to projection optics where input and output couplings are on a same side of the waveguide.

FIGS. 8A and 8B schematically illustrate an effect of a misalignment of a waveguide with respect to projection optics where input and output couplings are on opposite sides of the waveguide in accordance with an embodiment of the present disclosure.

FIG. 9 shows a flow diagram depicting an embodiment of a method of operating a waveguide display.

FIG. 10 shows an example embodiment of a computing device.

### DETAILED DESCRIPTION

As mentioned above, a near-eye display may utilize one or more waveguides incorporated into a display (see-through or otherwise) configured to be positioned in front of a user's eye or eyes. In such a device, the waveguide may receive an image from a microdisplay at an input coupling, and transmit the image to an output coupling configured to direct the image toward a user's eye.

A color near-eye display may utilize a stack of waveguides to display color images, such that a separate waveguide is utilized for each color. Additionally, multiple waveguides may be provided for each color to provide a wider field of view for each color than may be achieved with one waveguide for each color. However, as described in more detail below, misalignment of a waveguide in a waveguide stack with other waveguides in the stack and/or other optics (such as projection optics) may give rise to additive errors in an angle of the light output by the waveguide. Such errors may be detected by the human eye if the departure from parallel between two waveguides is larger than the visual resolution of the human eye. Small errors (e.g. waveguides angularly offset from each other by ½ to 1 arcmin from parallel) may appear as blurred images, while larger errors (e.g. greater than 1 arcmin) may appear as multiple images.

Accordingly, embodiments are disclosed that relate to waveguide displays with less sensitivity to such alignment errors due to the input and output couplings of each waveguide being at opposite sides of the waveguide. In such a display, errors due to misalignment may substantially cancel, rather than increase additively at each coupling.

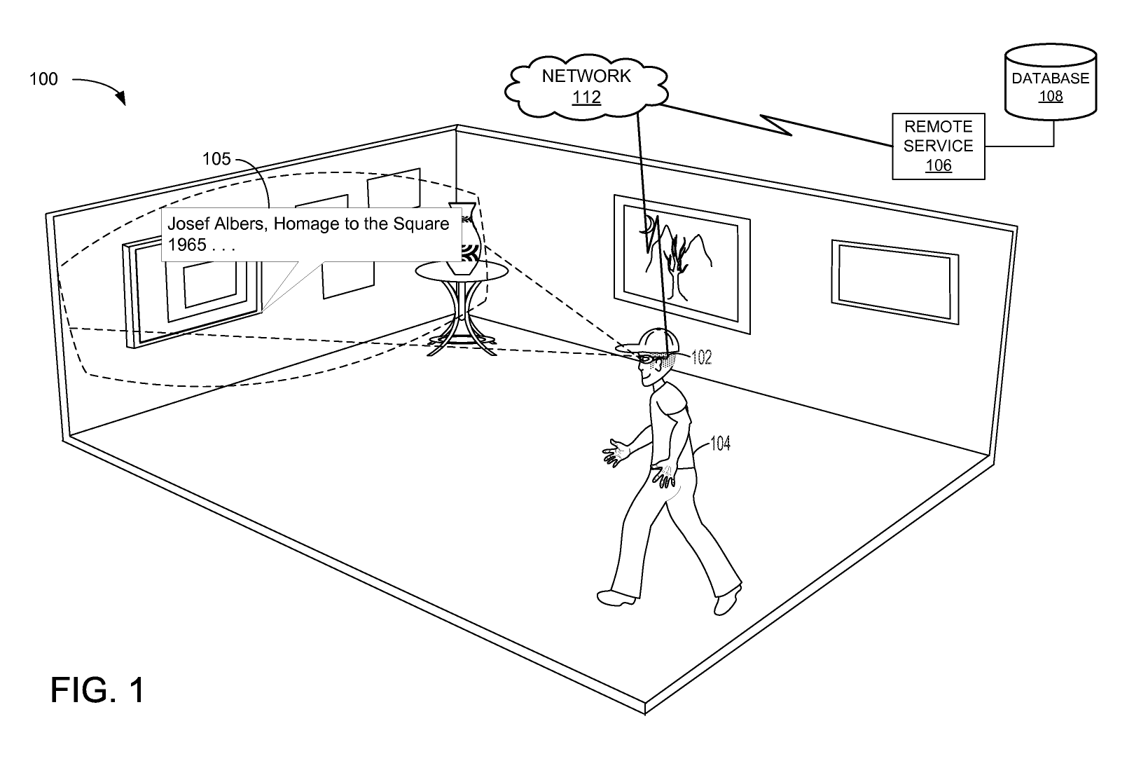

Prior to discussing such embodiments in detail, an example embodiment of a use environment 100 for a near-eye display device 102 is described with reference to FIG. 1. More specifically, FIG. 1 shows a user 104 wearing the near-eye display device 102 to view an augmented reality image of the use environment. The depicted near-eye display device 102 takes the form of a head mounted device (HMD) that allows both hands of the user 104 to be free to interact with other objects. The near-eye display device 102 includes a see-through display system configured to allow the visual augmentation of an appearance of the environment to the user 104. In other words, the see-through display allows light from the environment to pass through the see-through display so that the user 104 can directly see the actual environment in addition to one or more virtual objects displayed as an overlay to the actual environment.

In the depicted example, the near-eye display device 102 is displaying augmenting imagery in the form of one or more virtual objects 105 pertaining to information regarding one or more objects in the environment 100. The displayed information may be obtained in any suitable manner. For example, the displayed information may be stored locally on the near-eye display device 102, may be retrieved from a remote service 106 and database 108 via a network 112, and/or may be received in any other suitable manner

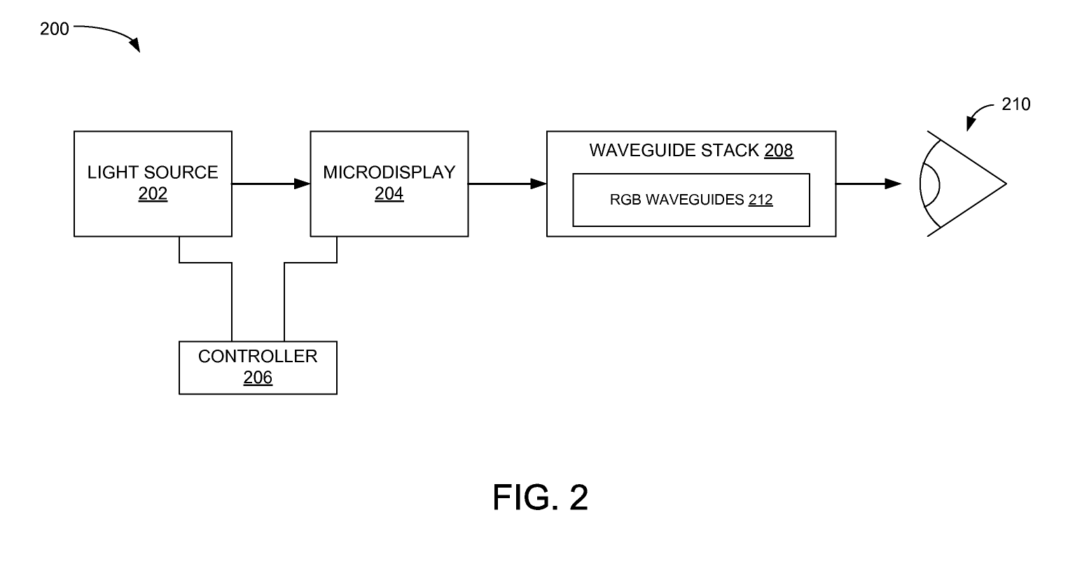

FIG. 2 shows a block diagram of a display subsystem 200 suitable for use with near-eye display device 102 of FIG. 1. The display subsystem 200 includes a light source 202 configured to provide light to a microdisplay 204 to produce an image. The light source 202 may utilize any suitable light source or sources, including but not limited to one or more laser diode light sources. As a more specific example, the light source 202 may utilize one or more of each of red, green, and blue laser diodes.

The light source 202 may project light onto one or more microdisplays 204. In some embodiments, a single microdisplay may be used to generate images in a color field-sequential manner, while in other embodiments, separate microdisplays may be used for each color to allow the simultaneous display of colors. Further, in some embodiments, a separate microdisplay (or arrangement of plural microdisplays) may be used for each eye. Any suitable type of microdisplay may be used, including but not limited to one or more liquid crystal on silicon (LCOS) microdisplays. In yet other embodiments, one or more emissive microdisplays may be used (e.g. an organic light-emitting device microdisplay), such that light source 202 may be omitted.

A controller 206 may send control signals to the light source 202 and the microdisplay 204 to control the display of an image via the microdisplay 204. Light from the microdisplay may then be coupled into a waveguide stack 208 for delivery to an eye 210 of a user. The waveguide stack 208 includes a plurality of waveguides, such as separate waveguides for different colors (e.g. red, green and blue), as shown at 212. Further, in some embodiments, multiple waveguides may be provided for each color to help provide a wider field of view for each color than may be achieved with one waveguide for each color. It will be understood that these embodiments are described for the purpose of example, and are not intended to be limiting in any manner. For example, a single color display may utilize a single waveguide.

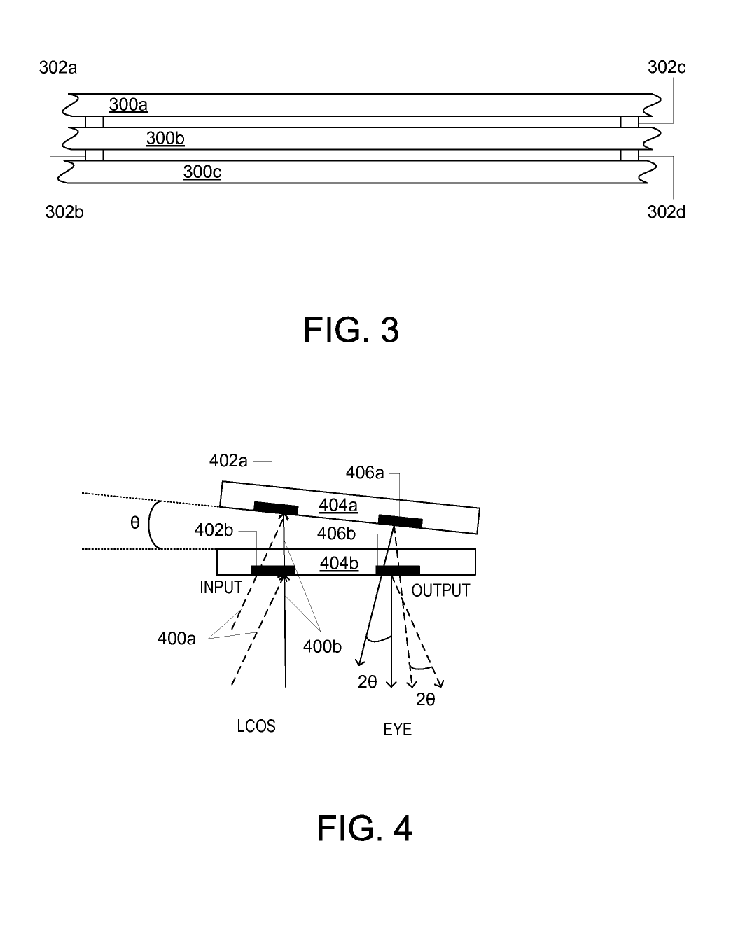

FIG. 3 is a schematic representation of an embodiment of a waveguide stack 208 comprising three waveguides 300a, 300b, and 300c. As depicted, each waveguide is separated from adjacent waveguides by spacers, shown at 302a-d. Due to the sensitivity of the human eye, if input and output couplings for each waveguide are at a same side of the waveguide, any departure of the waveguides from parallel with respect to each other may cause blurring or multiple images, depending upon the magnitude of the angle between the waveguides. This is illustrated schematically in FIG. 4, which shows two sets of parallel rays 400a, 400b entering input couplings 402a, 402b of two non-parallel waveguides 404a, 404b. If the angle between the waveguides with respect to parallel is expressed as θ, then each initially parallel set of rays is angularly offset from parallel by an angle of 2θ upon exiting the output couplings 406a, 406b of the pair of waveguides. Thus, the error accumulates additively at each coupling.

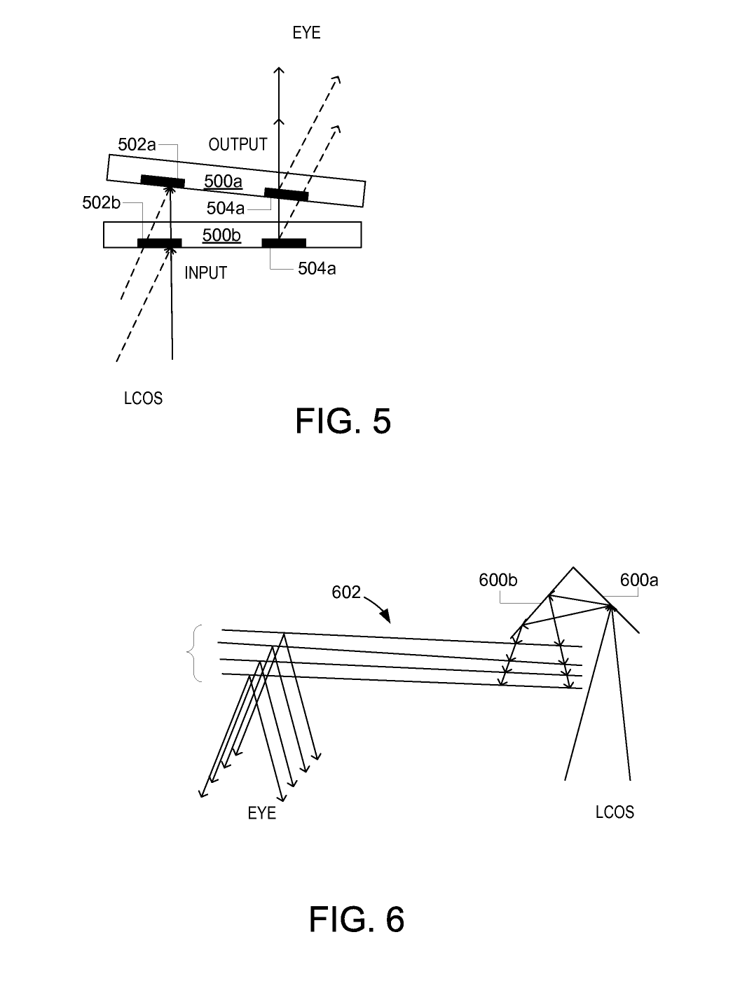

In contrast, FIG. 5 illustrates two non-parallel waveguides 500a, 500b each having input couplings 502a, 502b and output couplings 504a, 504b at opposite sides of the waveguide. With such a configuration, instead of errors accumulating additively, any error arising at the input couplings 502a, 502b from the misalignment is offset by an opposite error arising at the output couplings 504a, 504b, resulting in a substantial reduction in net error. Thus, by utilizing input and output couplings at opposite sides of a waveguide, errors arising from misalignment of the waveguides may be substantially mitigated. This may help to simplify manufacturing, as tolerances regarding the construction and assembly of waveguides and spacers for spacing the waveguides may be loosened (e.g. waveguides within a few degrees of parallel) compared to a waveguide display device with input and output couplings at a same side of each waveguide (e.g. waveguides less than 1 arcmin from parallel).

It will be understood that the input couplings 502a, 502b and the output couplings 504a, 504b may couple light into and out of the waveguides 500a, 500b in any suitable manner, such as via diffractive and/or reflective mechanisms. It further will be understood that the mitigating effects of locating the input and output couplings on opposite sides of the waveguide may be greatest when a prescription of the input coupling and the output coupling are the same. However, in some embodiments, the input coupling and output coupling may have different prescriptions where suitable.

Light may be delivered to the input coupling in any suitable manner. For example, in some embodiments, light may be delivered from a light source (e.g. a emissive microdisplay or spatial light modulating microdisplay) at the same side of the waveguide(s) as a user's eye to an input coupling(s) at an opposite side of the waveguide(s). In such an embodiment, one or more reflective structures may be used to receive light from around an edge of the waveguide(s) and to reflect the light back toward the input coupling(s). It will be understood that the term “reflective structure” represents any suitable structure for reflecting light, including but not limited to metallic mirrors, multilayer dielectric minors, total internal reflection elements, etc. FIG. 6 shows an example embodiment of such a configuration, wherein two minors 600a, 600b are used to reflect light into the input couplings of a waveguide stack 602 comprising four waveguides. In other embodiments, any other suitable arrangement of and number of reflective elements may be used. Further, in yet other embodiments, a light source may be at an opposite side of the display as a user's eye. In some of such embodiments, light may be input into the input coupling without utilizing reflective structures.

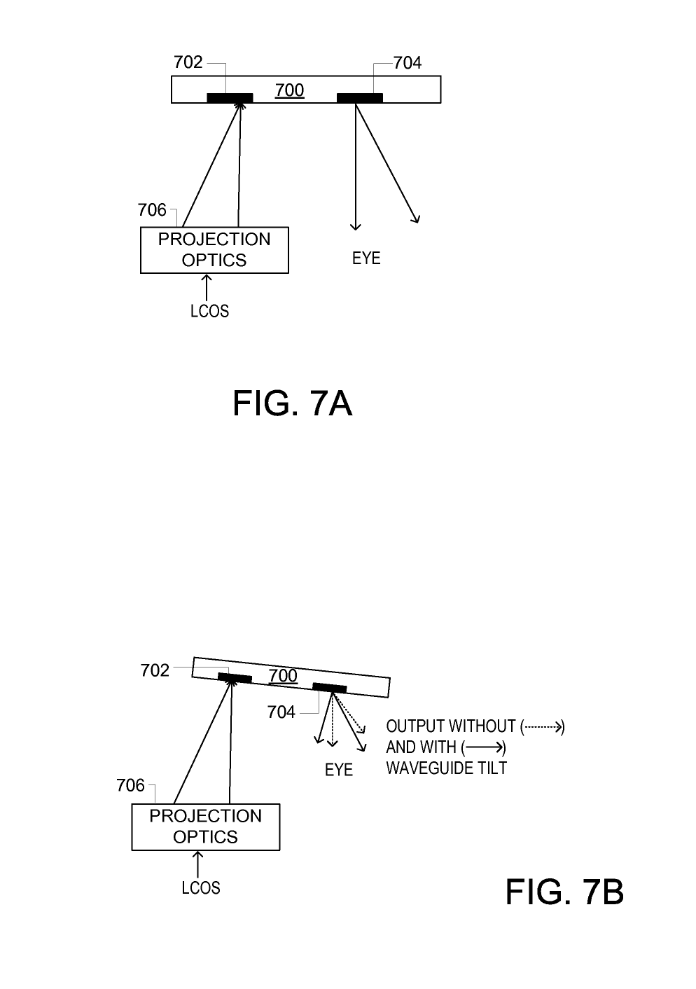

In addition to mitigating errors caused by waveguide misalignment, locating input and output couplings of a waveguide display on opposite sides of a waveguide also may help to correct for misalignments of a waveguide with respect to other optics in an optical system. For example, FIGS. 7A and 7B schematically depict an embodiment of a single waveguide 700 comprising an input coupling 702 and an output coupling 704 at a same side of the waveguide, and also depicts projection optics 706 positioned such that light from the projection optics 706 passes into the waveguide 700 via the input coupling 702. FIG. 7A illustrates the waveguide 700 being aligned correctly with the projection optics, while FIG. 7B illustrates the waveguide 700 being tilted relative to the projection optics 706. As shown, when the waveguide 700 is tilted relative to the projection optics 706, light exits the waveguide in an angularly shifted direction due to the misalignment with the projection optics.

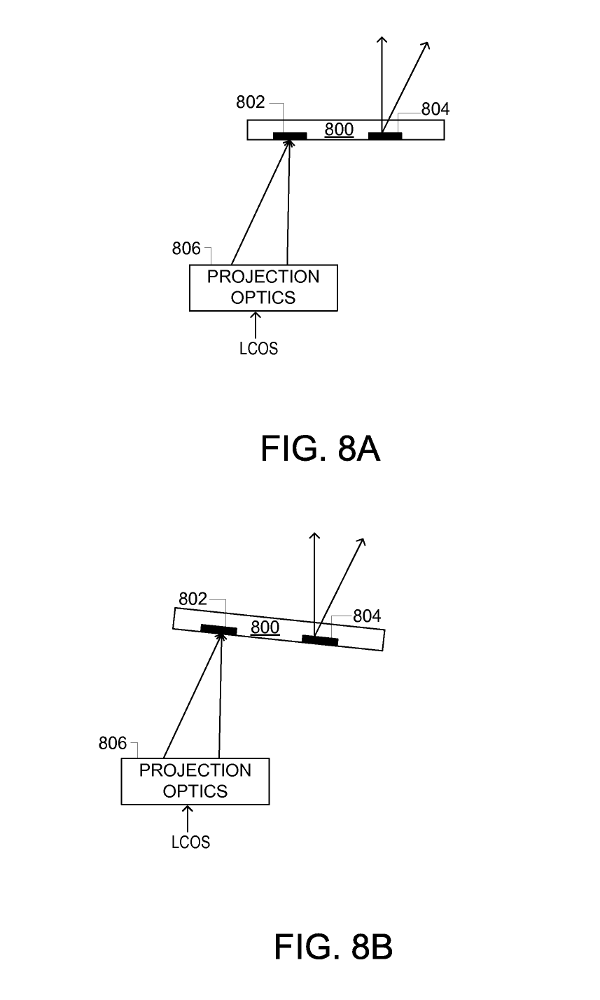

In contrast, in a waveguide having input and output couplings on opposite sides of the waveguide, the angular offset introduced at the input coupling is mitigated by the angular offset at the output coupling, such that light exits the waveguide in an intended direction. FIGS. 8A-8B schematically illustrates an embodiment of a single waveguide 800 comprising an input coupling 802 and an output coupling 804 at opposite sides of the waveguide 800, and also depicts projection optics 806 positioned such that light from the projection optics 806 passes into the waveguide 800 via the input coupling 802. FIG. 8A illustrates the waveguide 800 being aligned correctly with the projection optics, while FIG. 8B illustrates the waveguide 800 being tilted relative to the projection optics 806. As shown, even when the waveguide 800 is tilted relative to the projection optics 806, light exits the waveguide along substantially the same direction as in the properly aligned example. Therefore, utilizing a waveguide with input and output couplings located at opposite sides of the waveguide may help to mitigate misalignments of the waveguide with optics outside of a waveguide stack, as well as mitigating errors that arise from non-parallel waveguides in the waveguide stack.

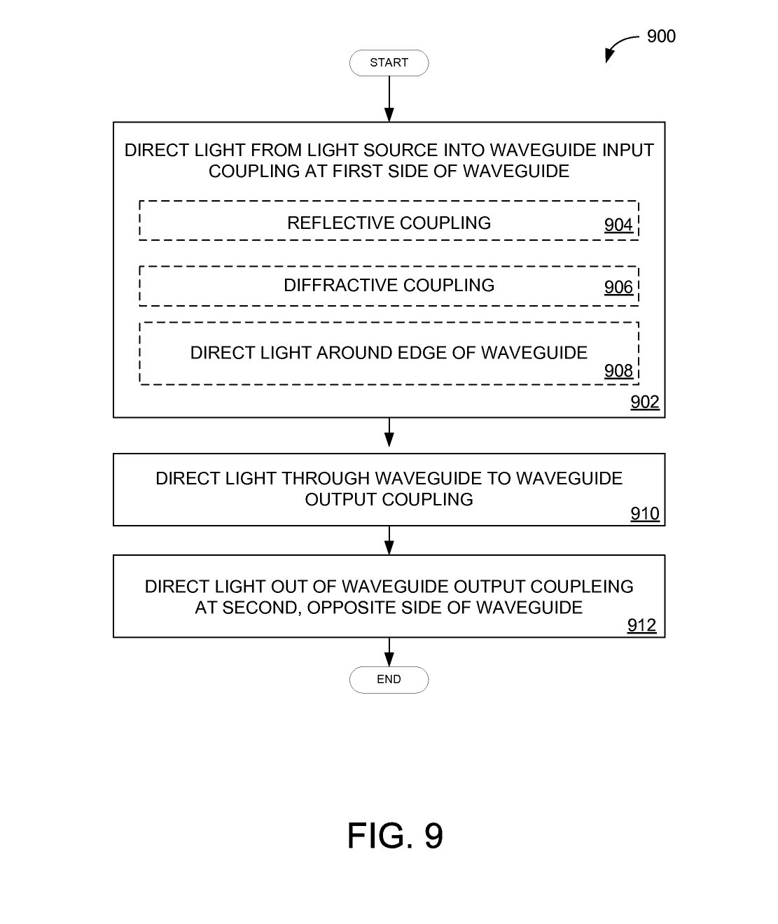

FIG. 9 shows a flow diagram depicting an embodiment of a method 900 for operating a waveguide near-eye display. The waveguide display may comprise one or more waveguides. For example, a color waveguide display may comprise a waveguide for each displayed color, and potentially more than one waveguide for each color to increase a field of view of the waveguide display. The near-eye display may be incorporated in any suitable type of display device, including but not limited to a head-mounted display device.

Method 900 comprises, at 902, directing light from a light source (e.g. an image producing element) into an input coupling located at a first side of the waveguide. As depicted, the coupling may comprise one or more of a reflective coupling 904 and a diffractive coupling 906. Where the waveguide display comprises a stack of multiple waveguides, light may be coupled into each waveguide of the stack of waveguides via diffractive and/or reflective mechanisms.

In some embodiments, the light source may be at a same side of the waveguide display as a user's eye. Thus, in such embodiments, method 900 may further comprise directing light around an edge of the waveguide, as indicated at 908, in order to couple the light into the waveguide at the input coupling. Any suitable reflective structure or structures may be used. Examples include, but are not limited to, minors, multilayer dielectric minors, and total internal reflection structures.

Continuing, method 900 next comprises, at 910, directing light from the input coupling, through the waveguide, and then out of the waveguide via an output coupling at a second, opposite side of the waveguide as the waveguide input coupling. In this manner, errors that may arise from misalignment of waveguides with each other (e.g. where waveguides in a waveguides stack are not parallel) and/or misalignment of the waveguide(s) with other optics, such as projection optics, may be mitigated compared to a waveguide with input and output couplings at a same side.

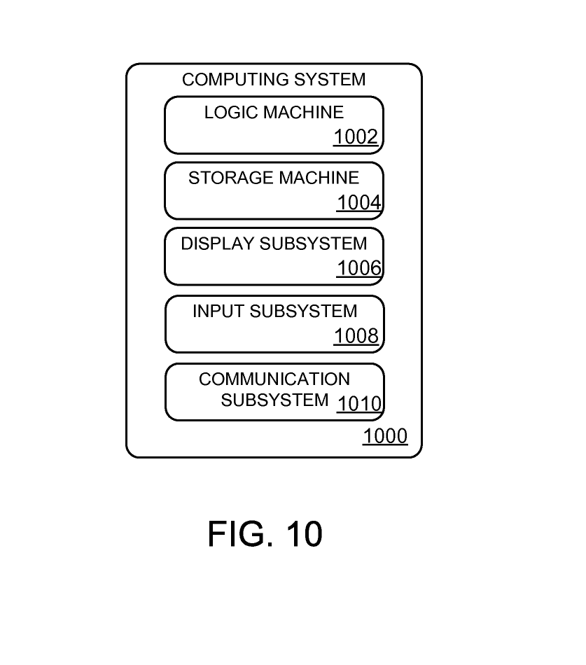

FIG. 10 schematically shows a non-limiting embodiment of a computing system 600 that can enact one or more of the methods and processes described above. Computing system 1000 is shown in simplified form. Computing system 1000 may take the form of a head-mounted see-through display device, as well as any other suitable computing system, including but not limited to gaming consoles, personal computers, server computers, tablet computers, home-entertainment computers, network computing devices, mobile computing devices, mobile communication devices (e.g., smart phone), and/or other computing devices.

Computing system 1000 includes a logic machine 1002 and a storage machine 1004. Computing system 1000 may also include a display subsystem 1006, input subsystem 1008, communication subsystem 1010, and/or other components not shown in FIG. 10.

Logic machine 1002 includes one or more physical devices configured to execute instructions. For example, the logic machine may be configured to execute machine-readable instructions that are part of one or more applications, services, programs, routines, libraries, objects, components, data structures, or other logical constructs. Such instructions may be implemented to perform a task, implement a data type, transform the state of one or more components, achieve a technical effect, or otherwise arrive at a desired result.

The logic machine may include one or more processors configured to execute software instructions. Additionally or alternatively, the logic machine may include one or more hardware or firmware logic machines configured to execute hardware or firmware instructions. Processors of the logic machine may be single-core or multi-core, and the instructions executed thereon may be configured for sequential, parallel, and/or distributed processing. Individual components of the logic machine optionally may be distributed among two or more separate devices, which may be remotely located and/or configured for coordinated processing. Aspects of the logic machine may be virtualized and executed by remotely accessible, networked computing devices configured in a cloud-computing configuration.

Storage machine 1004 includes one or more physical devices configured to hold instructions executable by the logic machine to implement the methods and processes described herein. For example, controller 206 of FIG. 2 may include and/or be in operative communication with logic machine 1002 and/or storage machine 1004 in order to control the light source 202 and/or the microdisplay 204. When such methods and processes are implemented, the state of storage machine 1004 may be transformed—e.g., to hold different data.

Storage machine 1004 may include removable and/or built-in devices. Storage machine 1004 may include optical memory (e.g., CD, DVD, HD-DVD, Blu-Ray Disc, etc.), semiconductor memory (e.g., RAM, EPROM, EEPROM, etc.), and/or magnetic memory (e.g., hard-disk drive, floppy-disk drive, tape drive, MRAM, etc.), among others. Storage machine 1004 may include volatile, nonvolatile, dynamic, static, read/write, read-only, random-access, sequential-access, location-addressable, file-addressable, and/or content-addressable devices.

It will be appreciated that storage machine 1004 includes one or more physical devices. However, aspects of the instructions described herein alternatively may be propagated by a communication medium as a signal (e.g., an electromagnetic signal, an optical signal, etc.), as opposed to being stored on a physical device.

Aspects of logic machine 1002 and storage machine 1004 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

When included, display subsystem 1006 may be used to present a visual representation of data held by storage machine 1004. This visual representation may take the form of a graphical user interface (GUI). As the herein described methods and processes change the data held by the storage machine, and thus transform the state of the storage machine, the state of display subsystem 1006 may likewise be transformed to visually represent changes in the underlying data. Display subsystem 1006 may include one or more display devices utilizing virtually any type of technology, including but not limited to the near-eye display systems described herein. Such display devices may be combined with logic machine 1002 and/or storage machine 1004 in a shared enclosure, or such display devices may be peripheral display devices.

When included, input subsystem 1008 may comprise or interface with one or more user-input devices such as a keyboard, mouse, touch screen, microphone, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity.

When included, communication subsystem 1010 may be configured to communicatively couple computing system 1000 with one or more other computing devices. Communication subsystem 1010 may include wired and/or wireless communication devices compatible with one or more different communication protocols. As non-limiting examples, the communication subsystem may be configured for communication via a wireless telephone network, or a wired or wireless local- or wide-area network. In some embodiments, the communication subsystem may allow computing system 1000 to send and/or receive messages to and/or from other devices via a network such as the Internet.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. A near-eye display device, comprising:
one or more waveguides;
for each waveguide, a light input coupling configured to receive light at a first side of the waveguide to couple the light into the waveguide; and
for each waveguide, a light output coupling configured to emit light from the waveguide at a second side of the waveguide, the second side of the waveguide being opposite the first side of the waveguide.

2. The near-eye display device of claim 1, further comprising a plurality of waveguides, wherein each waveguide of the plurality of waveguides is separated from an adjacent waveguide via one or more spacers.

3. The near-eye display device of claim 1, wherein one or more light input couplings comprises a diffractive coupling.

4. The near-eye display device of claim 1, wherein one or more light input couplings comprises a reflective coupling.

5. The near-eye display device of claim 1, further comprising a reflective structure configured to redirect light received from the light source into the input couplings.

6. The near-eye display device of claim 1, wherein, for each waveguide, the input coupling and the output coupling have a same prescription.

7. The near-eye display device of claim 1, wherein the near-eye display device comprises a head-mounted display.

8. A near-eye display device, comprising:
a microdisplay;
a waveguide stack including
a plurality of waveguides separated by one or more spacers,
an input coupling configured to receive light input at a first side of the waveguide stack, and
an output coupling configured to emit light from a second, opposite side of the waveguide stack as the first side; and
a reflective structure configured to direct light from the microdisplay received from around an edge of the waveguide stack into the input coupling at the first side of the waveguide stack.

9. The near-eye display device of claim 8, wherein the light input coupling comprises a diffractive coupling.

10. The near-eye display device of claim 8, wherein the light input coupling comprises a reflective coupling.

11. The near-eye display device of claim 8, wherein the input coupling and the output coupling have a same prescription.

12. The near-eye display device of claim 8, further comprising a head-mounted display.

13. A method of directing light to a user of a near-eye display, the method comprising:
directing light from a light source into an input coupling at a first side of a waveguide;
directing light through the waveguide to an output coupling; and
directing light out of the output coupling at a second side of the waveguide, wherein the second side is different than a first side.

14. The method of claim 13, wherein the near-eye display comprises a waveguide stack, and wherein directing light from the light source into the input coupling at the first side of the waveguide comprises coupling light into each waveguide of the waveguide stack at the first side of the waveguide.

15. The method of claim 13, wherein directing light from the light source into the input coupling comprises redirecting the light received from the light source into the input coupling via one or more reflective elements.

16. The method of claim 15, wherein redirecting the light received from the light source comprises reflecting the light around an edge of a waveguide and toward the input coupling via an arrangement of one or more reflective structures.

17. The method of claim 13, wherein the input coupling comprises a diffractive input coupling.

18. The method of claim 13, wherein the input coupling comprises a reflective input coupling.

19. The method of claim 13, wherein the input coupling and the output coupling have a same prescription.

20. The method of claim 13, wherein directing light out of the output coupling comprises directing light out of a near-eye display of a head-mounted display system.
